(19) United States
(12) Patent Application Publication
(10) Pub. No.: US 2005/0011368 A1
(43) Pub. Date: Jan. 20, 2005

(54) Deep fat fryer

(76) Inventor: Johan Falk, Molndal (SE)

Correspondence Address: HARNESS, DICKEY & PIERCE, P.L.C., P.O. BOX 8910, RESTON, VA, 20195, US

(21) Appl. No.: 10/496,182

(22) PCT Filed: Nov. 20, 2002
(86) PCT No.: PCT/SE02/02112

(30) Foreign Application Priority Data
Nov. 20, 2001 (SE) 0103843-9

(51) Int. Cl. A47J 37/12

(52) U.S. Cl. 99/404

(57) ABSTRACT

A deep fat fryer (1) for deep frying food includes a container for oil. The deep fat fryer (1) also includes a track conveyor for the continual deep frying of food, where the track conveyor is arranged so that, when in use, it conveys food through the oil in said container. A procedure for deep frying food includes the stage where the food is conveyed along a track in the oil.

### TECHNICAL AREA

The invention in question concerns a deep fat food fryer. The deep fat fryer includes a container for the oil.

Furthermore, the invention in question refers to a procedure for deep frying food.

### TECHNICAL BACKGROUND

Deep fat fryers of the kind specified in the introduction are well-known. They are mainly to be found in fast food restaurants and are primarily used for frying chips. Other foods, such as onion rings, can also be deep fried. A large quantity of chips is normally poured into a wire basket which is then lowered into the cooking oil. After a given time, the contents of the basket can be removed and portioned out. One problem with the traditional deep frying method is that the food must be supervised in order to prevent over-frying or under-frying. However, solutions exist where the wire basket is suspended on an electrically controlled lift so that the basket is automatically lifted out of the oil after a set time.

As relatively large quantities of food are deep fried at the same time, it is also necessary for the wire basket to be shaken from time to time to mix the food. Failure to do so will result in the food in the middle of the basket not being cooked as well as. the food at the sides. This shaking, which is not always carried out, is also insufficient to allow adequate redistribution of the food. In addition, the time required for deep frying is relatively long and this is particularly noticeable in fast food restaurants.

### SUMMARY OF THE INVENTION

The purpose of the invention in question is to eliminate the above problems as well as to provide a deep fat fryer with additional advantages.

This can be achieved through an appliance and a procedure that demonstrate the distinctive features indicated in the enclosed patent requirement.

The innovative deep fat fryer utilises a track conveyor for continual deep frying of food, where the track conveyor is adapted to convey the food through the oil in the container. A major advantage with this solution is that, in this way, the food is spread out along a track allowing it to be deep fried continually, before being automatically removed from the oil when the deep frying process has been completed. Consequently, there is also the advantage that the food looks after itself, so to speak, and does not need to be supervised. For example, the frozen food can be loaded into a large container which continually feeds food onto the track conveyor.

In order to dispense with yet another stage in the operation, it is necessary for the food to be divided into sections corresponding to the size of individual portions. This can be done using separator units which are ideally fitted to the moving track. In the event of the track sloping steeply or completely vertically, these separator units help to convey the food, thereby avoiding track stoppages. These separator units should ideally be perforated to allow the oil to flow through, while at the same time being sufficiently tightly meshed to prevent the food from falling through.

In order to reduce the time taken for deep frying, it is a good idea to fit a pump to circulate the oil. In the existing technology, the wire basket is lowered into a container of static oil. By circulating the oil, the deep frying time is consequently reduced as a result of increased convection, i.e. the transference of heat from the oil to the food.

In order to further reduce the time taken and to improve hygiene, a filter is ideally installed to filter the oil. Small particles which have broken away from the food are commonly found in the oil and may be deposited on subsequently deep fried items of food, insulating them and resulting in poorer heat transference. By filtering the oil, it will also become cleaner, i.e. more hygienic. To further improve hygiene, it is advisable for the track conveyor to be built in such a way that the only openings are for loading and unloading the food, thus preventing anything else from accidentally falling into the oil.

A further improvement of the heat transference is achieved by allowing the oil to be sprayed directly onto the food, preferably along the whole length of the track conveyor. This can be achieved by perforating one of the track conveyor's side walls and applying pressure to the side of this wall facing away from the food. In this way, the oil flows through the perforations directly onto the food. Alternatively, the perforations can be designed to form nozzles to increase the speed of the oil.

Furthermore, the time taken can be reduced and the quality of the fried food improved by means of the track conveyor transporting the food to a depth of oil in excess of approximately 30 cm. The increased pressure results in quicker heat transference. It has been shown that a depth of around 80 cm is ideal. Naturally, it is possible to submerge the food to a greater depth, although at the expense of an increase in the size of the deep fat fryer.

When deep frying frozen food, a coat forms around the item of food, for example when the frozen water disappears immediately following submersion into the oil. It is consequently beneficial for the track conveyor to be adapted so that, during use, it initially conveys food at a starting depth in the oil along a flat trajectory, before taking the same food to a second depth, greater than the first depth, where the food is conveyed along a flat trajectory at this second depth. In this way, the water given off by the food is allowed to rise freely to the surface of the frying liquid. The food is then taken down to a greater depth for continued deep frying.

Changing the direction of the track conveyor at the same time as the track goes deeper into the oil ensures redistribution of the food.

### BRIEF DESCRIPTION OF FIGURES

From now on, the invention will further described by means of a version example, with reference to enclosed figures.

FIG. 1 is an overview of a currently submitted version of the deep fat fryer in accordance with the invention in question.

FIG. 2 is an overview of a wall in the deep fat fryer in FIG. 1.

FIG. 3 is an overview of the wall in FIG. 2 with transport channels.

### DESCRIPTION OF SUBMITTED VERSIONS

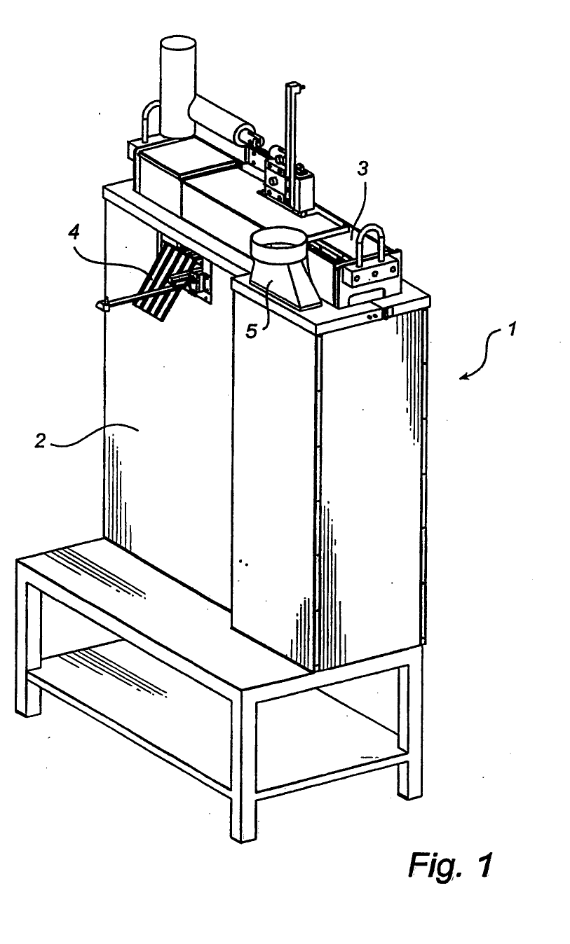

The deep fat fryer (1) in FIG. 1 includes a casing (2), a loading opening (3) and an unloading opening (4). In a submitted version of the deep fat fryer (1) in accordance with the invention in question, the entire deep frying process is enclosed for optimum hygiene. A further advantage of enclosing the process is a reduction in energy consumption, because the heat output resulting from evaporation is minimised as the total area of the oil in contact with air is minimal. A further consequence of the reduced evaporation is a reduction in the consumption of oil. The reduced contact between the oil and oxygen means that the lifetime of the oil is extended, which also means a saving on oil which would otherwise have to be replaced more frequently. Ideally, the oil is circulated in deep fat fryer (1) and is filtered in order further to improve product durability and hygiene.

In a submitted version of the deep fat fryer (1) in accordance with the invention in question, a device (5) is fitted to the deep fat fryer (1) for connection to an exhaust air duct (not shown). This solution results in a significantly improved working environment for those working with machine (1), in that they avoid having to work in the cooking fumes as is the case with traditional deep fat fryers.

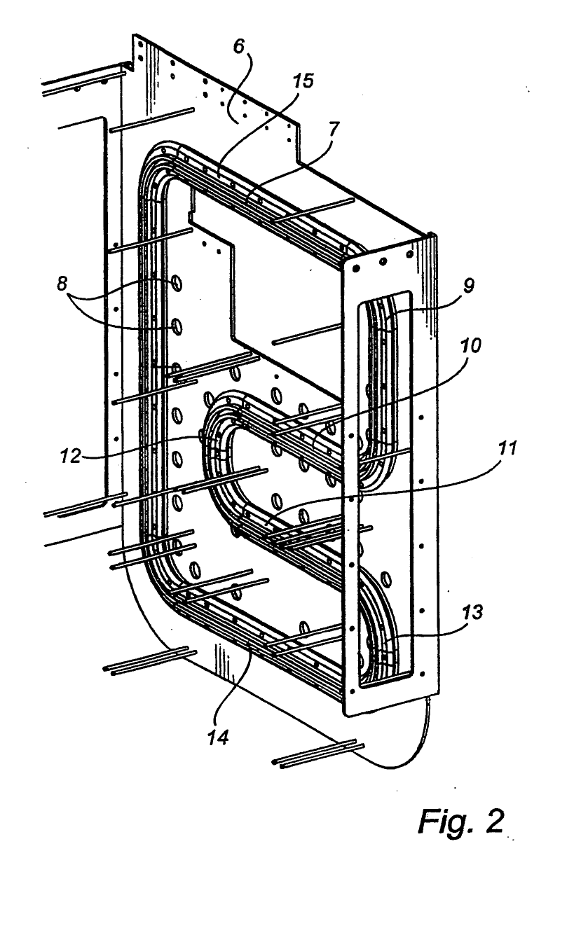

FIG. 2 shows a wall (6) in the deep fat fryer (1). The wall (6) is fitted with a guide rail (7) that follows the track conveyor. In a submitted version of the wall (6) in accordance with the invention in question, the wall (6) is supplied with openings (8) which are spread out along the track conveyor. When using the deep fat fryer (1), the oil is pressurised on the side of the wall (6) facing away in FIG. 2. This pressurisation results in the oil being sprayed through openings (8) directly onto the food on the track conveyor.

During deep frying, food is conveyed into the track conveyor at a starting position (9) and the track conveyor takes the food down into the oil to an initial depth (10). At the indicated initial depth (10), the food is transported in a flat trajectory before being transported further down to a second depth (11) where the food is transported in a flat trajectory. The track conveyor also changes direction at transition (12) from the first depth (10) to the second depth (11), which means that the food is mixed. From second depth (11) the food is transported via a second transition (13) to a third depth (14) where the food is also transported along a flat trajectory. The food is then conveyed up above the oil so that the oil runs off before the food is unloaded from the track conveyor at a second position (15).

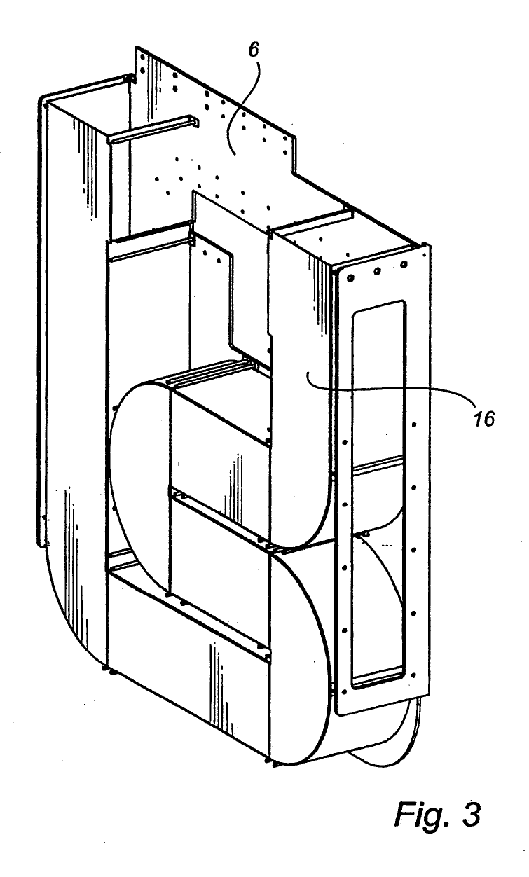

FIG. 3 shows the wall (6) from FIG. 2 with the transport channel (16) drawn in. In a submitted version of the deep fat fryer in accordance with the invention in question, the separator units (not shown) are designed such that they can pass through the transport channel (16) and at the same time convey the food in portions through the entire transport channel (16).

It is realised that a number of modifications to the version of the invention described above are possible within the framework of the invention, as defined by the following patent requirements. As is described above, for example, the track conveyor can be arranged in a number of different ways. Furthermore, the openings (8) can be fitted with nozzles to optimise the oil's flow rate.

1. Deep fat fryer for deep frying food, comprising:
container for oil;
a track conveyor for continual deep frying of food, wherein the track conveyor is arranged so that, when in use, it conveys food through the oil to a depth of oil is greater than 30 cm in said container.

2. Deep fat fryer as claimed in claim 1, wherein the track conveyor includes at least one separator unit for dividing the food into portions.

3. Deep fat fryer as claimed in claim 1, further comprising a pump, fitted to circulate the oil.

4. Deep fat fryer as claimed in claim 1, further comprising a filter, fitted to filter the oil.

5. Deep fat fryer as claimed in claim 1, in wherein at least one wall of the track conveyor includes openings through which oil is sprayable directly onto the food.

6. Deep fat fryer as claimed in claim 1, wherein the track conveyor is arranged so that, when in use, it conveys food to a depth of oil of around 80 cm.

7. Deep fat fryer as claimed in claim 1, wherein the track conveyor is arranged so that, when in use, it initially conveys food to a first depth in the oil along a flat trajectory, before transporting the same food to a second depth, wherein the second depth is greater that the first depth, and wherein the food is conveyed along a flat trajectory at the indicated second depth.

8. Deep fat fryer as claimed in claim 1, wherein the track conveyor is arranged so that there is a change of direction when changing the depth of the track in order to mix the food.

9. Procedure for deep frying food, comprising:
conveying the food along a track in oil to a depth of oil greater than 30 cm.

10. Procedure as claimed in claim 9, further comprising:
dividing the food into portions.

11. Procedure as claimed in claim 9, wherein the food is conveyed to a depth of oil of around 80 cm.

12. Procedure as claimed in claim 9, wherein conveying includes initially conveying the food to a first depth in the oil and then to a second depth in the oil, wherein the second depth is greater than the first depth.

13. Procedure as claimed in claim 9, wherein the food is conveyed along a track, a part of the track submerged in the oil being fitted with side walls, wherein at least one of the said walls includes openings through which oil is sprayed onto the food.

14. Deep fat fryer as claimed in claim 3, further comprising a filter, fitted to filter the oil.

15. Deep fat fryer as claimed in claim 7, wherein the track conveyor is arranged so that there is a change of direction when changing the depth of the track in order to mix the food.

16. Deep fat fryer for deep frying food, comprising:
means for holding oil;
means for conveying food through the oil to a depth of oil greater than 30 cm in said means for holding.

17. Deep fat fryer as claimed in claim 16, wherein at least one wall of the means for conveying includes openings through which oil is sprayed directly onto the food.

18. Deep fat fryer as claimed in claim 16, wherein the means for conveying is arranged so that, when in use, it conveys food to a depth of oil of around 80 cm.

19. Deep fat fryer as claimed in claim 16, wherein the means for conveying is arranged so that, when in use, it initially conveys food to a first depth in the oil along a flat trajectory, before transporting the same food to a second depth, wherein the second depth is greater that the first depth, and wherein the food is conveyed along a flat trajectory at the indicated second depth.

20. Deep fat fryer as claimed in claim 16, wherein the means for conveying is arranged so that there is a change of direction when changing the depth in order to mix the food.
